(19) United States
(12) Patent Application Publication
(10) Pub. No.: US 2010/0005028 A1
(43) Pub. Date: Jan. 7, 2010

(54) METHOD AND APPARATUS FOR INTERCONNECTING A PLURALITY OF VIRTUAL WORLD ENVIRONMENTS

(75) Inventors: John Hartley, North Fitzroy (AU); Neil Penman, West Brunswick (AU)

Correspondence Address: Snell & Wilmer L.L.P. (IBM Corp), 600 Anton Blvd, Suite 1400, Costa Mesa, CA, 92626, US

(73) Assignee: International Business Machines Corporation, Armonk, NY (US)

(21) Appl. No.: 12/168,717

(22) Filed: Jul. 7, 2008

(51) Int. Cl. H04L 9/32

(52) U.S. Cl. 705/50

(57) ABSTRACT

The present invention relates to a method and apparatus to interconnect a plurality of three-dimensional, computer-generated virtual worlds. More specifically, the present invention relates to moving avatars, or electronic representations of users, and their related attributes and assets between multiple independent virtual worlds. Existing virtual worlds are proprietary electronic islands. Users cannot move avatars between existing virtual worlds. The invention uses bi-lateral pipes, also known as virtual worm holes, to interconnect existing virtual worlds. The virtual worm holes facilitate data transfer and communication between existing independent virtual worlds, allowing users to move avatars from one virtual world to another while retaining their avatars' attributes and assets.

### BACKGROUND

1. Field of the Invention

The present invention relates to a method and apparatus to interconnect a plurality of three-dimensional, computer-generated virtual worlds. More specifically, the present invention relates to moving avatars and their related attributes and assets between multiple independent virtual worlds.

2. Description of Related Art

Computers have become much more pervasive in society. In addition, they have become more powerful, faster and have significantly more storage than they did just a few short years ago. The exponential increases in speed, storage and processor power has provided the necessary infrastructure for computers to network together effectively.

The most publicized computer network in existence is referred to as the Internet. The Internet is a connection of computers using the TCP/IP protocol. This has evolved into what is now referred to as the world wide web which provides a somewhat cognitive interface into the Internet. The world wide web allows users to access information by indicating the location of the information which they desire to retrieve or by traversing hyper-text links which cross-reference information in many different locations. This is made possible by the implementation of a universal resource locator (URL) as a way of locating information on the world wide web.

Many products have been developed which assist the user in searching the world-wide web for information. Access to the world wide web can be accomplished very inexpensively using a phone line, an inexpensive computer and a web browser such as Mozilla's Firefox™. This ability to inexpensively connect into the world wide web has encouraged its use for much more than business purposes. The world wide web is used for educational research, shopping, games, making reservations, trading stock and numerous other purposes. Children, as well as adults, are frequent users of the world wide web.

While it was the advent of two dimensional graphically intense web sites that spurred the popularity of the Internet, the next level of technology may bring the Internet, internal networks such as intranets, and networks in general to a new level. The intent of this phase of Internet development has been to render web sites sensually. That is, a user interacts with or exists within a site and experiences and perceives the site from within. This is referred to as Virtual Reality and is intended to perceptualize the network or to have the network rendered to humans with more of their senses, putting the user in the center of the Internet.

While Virtual Reality is still in its infancy, it traditionally uses computer simulations containing three-dimensional (3D) graphics and devices to allow the user to interact with the simulation. Much of what the user has been able to browse as “data” on the web may be able to be “experienced” as a 3D web site in the future. 3D web sites are constructed with a Virtual Reality Modeling Language, herein referred to as VRML, which allows for the design and implementation of platform-independent scene descriptions. VRML is a file format for describing interactive 3D objects and worlds to be experienced on the world wide web utilizing HTTP (a Hypertext Transfer Protocol used on the Internet) in its implementation.

VRML allows a computer program to construct three dimensional, viewable, representations of objects. These objects can then be placed on a web site, and viewed on the Internet, by any user that has a VRML enabled browser installed on the user's computer. These objects can be any object the VRML author can imagine, such as: telephones, houses, cityscapes, or three dimensional representations of data, or even animals or human characters. Initially these objects were inanimate, but enhancements to VRML have been made to allow for animation of objects existing in a world, in addition to allowing for sensors to be used to trigger preprogrammed responses from the objects with which they interact. Still objects have not been able to independently act with the user.

In an effort to place the user into the center of the Internet, the concept of an intelligent virtual object, called an avatar, has come into being. An avatar is a representation of the user which is embodied as a character so that the user can traverse the web as a representative being.

Avatars, as all other things which reside on the Internet, consist of computer programming. This can be in the form of executable code, definitions, tables, or any other form of program code recognizable to the system on which it is running. Hence, an avatar is in reality programming. An avatar is capable of containing additional programming to extend its functionality. Functions such as a file transfer protocol for data between two avatars can be implemented. Data such as documents, electronic cash, names, addresses or any other data the user wishes to exchange may be transferred from one avatar to another using predefined transfer protocols.

Avatars can be a collection of programming that may be distributed across multiple servers and ultimately determined by an end user. An avatar carries with it characteristics that are defined for that particular avatar. Characteristics such as shape, color, preference, personality and, credit and financial history are held with the avatar and will be transmitted with the avatar from server to server as the avatar traverses the Internet. This information determines the representation of the avatar in the worlds in which it resides.

While the use of avatars has been a significant step in traversing the Internet, conventional avatars are specific to a single virtual world. A user cannot move an avatar from one virtual world to another virtual world. Instead, the user must create a new avatar in the new virtual world.

Thus, there is a need for a method and apparatus for virtual world interconnectivity where users can move an avatar, along with the avatar's attributes and assets, between different virtual worlds.

### SUMMARY

In one embodiment, the invention relates to a method and apparatus to interconnect a plurality of three-dimensional, computer-generated virtual worlds, the method comprising the steps of: establishing a session in a first virtual world; selecting an asset from the first virtual world related to an avatar, the asset including a virtual personal item data or a virtual real estate holding data; determining if the asset is compatible with a second virtual world; connecting the first virtual world to the second virtual world by defining a link between the first virtual world and the second virtual world; encrypting the link to prevent a third-party access to data transmitted in the link; placing the asset in a virtual shipping container encrypted with a plurality of digital signatures; charging a transfer toll prior to transferring the avatar and the asset from the first virtual world to the second virtual world, the transfer toll payable through a virtual currency; transmitting a request to transfer the virtual shipping container from the first virtual world to the second virtual world; placing the shipping container in an escrow location pending an approval to transfer from the second virtual world; determining if the avatar has previously been accessed within the second virtual world; transferring the virtual shipping container, the avatar, and an authentication token from the first virtual world to the second virtual world through the link; receiving the virtual shipping container, the avatar, and the authentication token at an arrival terminal in the second virtual world; authenticating an identity of an avatar owner corresponding to the avatar using the authentication token; requesting a key from the first virtual world to decrypt the virtual shipping container; transmitting the key from the first virtual world to the second virtual world; unlocking the virtual shipping container with the key in the second virtual world; rendering the asset in the virtual shipping container through a rendering engine, the rendering of the asset irreversible; and maintaining the avatar in an invisible state in the second virtual world until the avatar exits the arrival terminal, the avatar remaining editable in the invisible state.

### BRIEF DESCRIPTION OF THE DRAWINGS

These and other embodiments of the invention will be discussed with reference to the following non-limiting and exemplary illustrations, in which like elements are numbered similarly, and where:

FIG. 1 is a diagram illustrating a sample network with a client station and multiple physical servers in which the present invention can be implemented;

FIG. 2 is a block diagram illustrating a sample network and two virtual worlds over multiple physical servers according to one embodiment of the present invention; and

FIG. 3 is a flowchart illustrating the process of moving an avatar from a first virtual world to a second virtual world.

### DETAILED DESCRIPTION

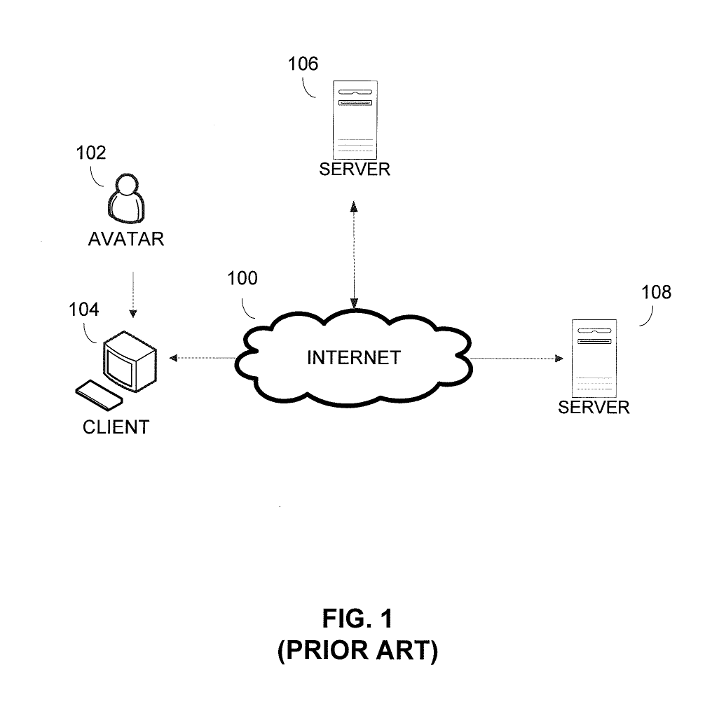

FIG. 1 is a diagram illustrating a sample network with a client station and multiple physical servers in which the present invention can be implemented. Client 104 corresponds to a system which allows a user or users to control an avatar 102. Each avatar 102 can be a three dimensional figure chosen by a user to represent the user in a virtual world. Avatar 102 appears on an on-screen display of client 104.

Client 104 interacts with servers 106 and 108 through Internet 100. Typically, but not always, client 104 can be implemented as a separate computer and one or more computer systems can be used to implement virtual world servers 106 and 108. As used here, the computer system could be a desktop computer, terminals, dedicated game controllers, workstations, or similar devices which have graphical displays and user input devices. The term “client” generally refers to a client machine, system and/or process, and is also used to refer to the client terminal and the user controlling the client terminal.

The user (not shown) interacts with client 104, and client 104 is networked to at least one of virtual world servers 106 or 108. Client 104 interacts with the at least one virtual world server 106 or 108 over network 100, which as an illustrative embodiment, can be a TCP/IP. In one embodiment, the link from client 104 to virtual world servers 106 and 108 comprises wire or cabling. The link can also be implemented using a wireless technology.

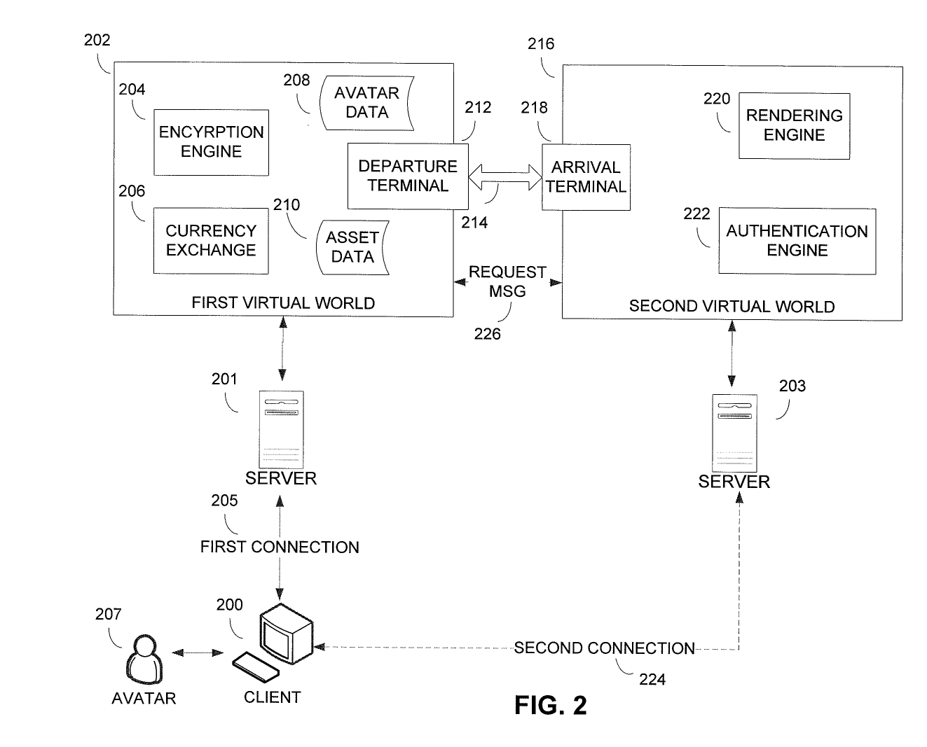

FIG. 2 is a block diagram illustrating a sample network and two virtual worlds over multiple physical servers according to one embodiment of the invention. A user (not shown) can control avatar 207 by interacting with client 200 which communicates instructions and data to first virtual world 202 through virtual world server 201. Client 200 establishes first connection 205 with virtual world server 201 in order to establish a session of first virtual world 202.

Referring to FIG. 2, first virtual world 202 includes asset data 210, avatar data 208, encryption engine 204, currency exchange 206, and departure terminal 212. Each of these features is described in more details below.

In an embodiment of the invention, the user may select asset data 210 relating to an asset or plurality of assets to move from first virtual world 202 to second virtual world 216. Selected asset data 210 can be placed into a virtual shipping container (not shown), and encrypted by encryption engine 204. In addition to asset data 210, attributes and characteristics, such as avatar appearance, may be placed into the virtual shipping container for transmission to second virtual world 216. Virtual shipping container may be an encrypted packet of data. Encryption engine 204 may be a combination of symmetric (secret-key) and asymmetric (public-key) data encryption to secure asset data 210 into the shipping container. Furthermore, an authenticating digital signature may be recorded onto the shipping container to prevent unauthorized access into the shipping container. The absence of the authenticating digital signature on encrypted shipping containers causes the shipping container to generate false asset data during an unauthorized access.

Asset data 210 related to an asset of avatar 207 can include, but is not limited to, virtual clothing items, virtual currency, virtual personal items, virtual real estate, such as virtual land and virtual buildings, as well as virtual beings such as virtual pets and virtual persons.

In another embodiment of the invention, the user may select not to encrypt the shipping container after selecting asset data 210 to transfer. In this embodiment, the shipping container is not encrypted or given a digital signature, and is transmitted to second virtual world 216 in an unsecured fashion.

In another embodiment of the invention, the user may be charged a toll or a fee to transfer asset data 210 from first virtual world 202 to second virtual world 216. The toll can be payable by virtual currency, or by physical hard currency. If the toll is paid by virtual currency, an electronic payment system, such as the payment system disclosed in US Publication 2006/0143435 to Kwon, or any other conventional payment systems may be utilized. If the toll is paid by physical hard currency, the user can make arrangements to transfer physical funds to the organization or individual in charge of administering second virtual world 216. Furthermore, the toll may be calculated based on a flat rate or calculated based on the data or memory size of asset data 210 or the number of individual assets selected as asset data 210 for transmission to second virtual world 216. In an embodiment of the present invention, a toll calculation engine (not shown) may be included.

In an embodiment of the present invention, the user may select virtual currency or virtual financial assets to transfer from first virtual world 202 to second virtual world 216. Just as traditional physical currency must usually be converted in order to be used in a foreign country, the virtual currency must be converted before it is usable in another independent virtual world. In one embodiment, currency exchange 206 is located within first virtual world 202, and coverts virtual currency from first virtual world 202 prior to a transfer of avatar data 208 and asset data 210 to second virtual world 216. In this embodiment, currency exchange 206 serves as a point-to-point currency converter between first virtual world 202 and second virtual world 216. Currency exchange 206 may be a database or table containing real-time virtual world currency exchange rates for a plurality of virtual world currencies, and may include information or links to such information such as virtual currency types and virtual currency exchange rates.

In another embodiment of the invention, currency exchange 206 is a third-party currency exchange provider, which is located outside of first virtual world 202. The third-party currency exchange provider is a mutually trusted provider and can handle currency exchanges between currencies from a plurality of virtual worlds.

Departure terminal 212 is located within first virtual world 202, and can be a graphical region within first virtual world 202 where the user, through avatar 207, can select asset data 210 for transport, as well as pay transfer tolls and exchange virtual currency. The user can perform these functions by interacting with client 200 through a mouse, keyboard, or other interaction means known in the art, and the user can view the graphical region on a display on client 200.

The user can select to transfer avatar data 208 and asset data 210 from first virtual world 202 to second virtual world 216 by interacting with client 200. Once the user selects to initiate a transfer, first virtual world 202 sends request message 226 to second virtual world 216. Second virtual world 216 receives request message 226 and can either accept or deny the transfer request. If second virtual world 216 accepts the request message, a bilateral communication link 214 is established between first virtual world 202 and second virtual world 216.

In an embodiment of the invention, the user, through avatar 207 or directly through interacting with client 200, can select a destination virtual world to move avatar data 208 and asset data 210, while avatar 207 is positioned within departure terminal 212. Furthermore, when the user has selected asset data 210 and identified a destination virtual world, the user can interact with client 200 to select a transfer option, which may be located in the graphical region within departure terminal 212.

When the transfer option is selected, first virtual world 202 transmits exchange request 226 to second virtual world 216. Second virtual world 216 can either accept or deny exchange request 226. If second virtual world 216 accepts exchange request 226, then first virtual world 216 may open a new browser window on client 200. First virtual world 216 will pass a session identifier identifying second virtual world 216 into a new browser window on client 200, which can be in the form of invoking the new browser window with a URL that includes a session identifier.

Link 214 is used to transmit avatar data 209 and asset data 210 from first virtual world 202 to second virtual world 216. In an embodiment of the present invention, link 214 is a secure link that is encrypted to prevent third-party intrusion into link 214 or to prevent access to data being transmitted through link 214.

In an embodiment of the invention, the user is given the option of maintaining a session of first virtual world 202 after a session has been initiated with second virtual world 216. In this case, avatar 207 remains active in both first virtual world 202 and second virtual world 206, the user can concurrently control a session of avatar 207 in both first virtual world 202 and second virtual world 206 through client 200. The session of avatar 207 in first virtual world 202 can be controlled independently from the session of avatar 207 in second virtual world 216. On the other hand, the user may select to terminate the session of first virtual world 202 after a session has been initiated in second virtual world 216.

In an embodiment, the user may have previously visited second virtual world 216 with avatar 207, or already has data stored in second virtual world 216. In this scenario, if the user transfers avatar data 208 and asset data 210 from first virtual world 202 to second virtual world 216, a new session of avatar 207 will emerge in second virtual world 216 at the same location and time that the user last controlled avatar 207 in second virtual world 216. However, the new session of avatar 207 will now have the additional avatar data 208 and asset data 210 in second virtual world 216.

In an embodiment of the invention, an authentication token can be transmitted along with avatar data 208 and asset data 210 from first virtual world 202 to second virtual world 216.

Second virtual world 216 can also include arrival terminal 218, rendering engine 220, and authentication engine 222. Each of these features is described in more details below. Avatar 201 is displayed to user through a display of client 200 as graphically located in arrival terminal 218 in second virtual world 216. Arrival terminal 218 can be a mode within second virtual world 216. This allows the user to adjust avatar 207 and remain invisible to other users. Avatars in second virtual world 216 remains editable until the user moves avatar 207 outside of arrival terminal 216.

Once in arrival terminal 218, virtual currency can be displayed in second virtual world 216 nomination that was brought as asset data 210 from first virtual world 202. Also, once in arrival terminal 218, the user has access to the contents of the shipping containers transmitted from first virtual world 202.

In an embodiment of the invention, when the user selects to unlock or decrypt the shipping container after arrival in second virtual world 216, asset data 210 contained in the shipping container will be transformed into equivalent usable assets in second virtual world 216. Shipping containers which have not been unlocked by the user may be transmitted back to first virtual world 202 with asset data 210 from first virtual world 202 intact, with the exception of any loss due to version corrosion. As an example, version corrosion may occur if asset data 210 is encrypted into a shipping container in first virtual world 202 version 1.0, but was transmitted back to first virtual world 202 version 1.1 from second virtual world 216. The variances between the first virtual world 202 versions may affect the backward-compatibility of earlier-encrypted asset data 210.

To unlock a shipping container in second virtual world 216 received from first virtual world 202, second virtual world 216 makes a request through link 214 or other communication channel to first virtual world 202. The request is an “unlock” request which, if accepted by first virtual world 202, prompts first virtual world 202 to transmit a digital key associated with the shipping container to second virtual world 216, where the key can be used to unlock the shipping container. Alternative forms of decryption may be used to unlock the shipping container, such as an encrypted key sent with asset data 210, or otherwise provided to the user for manual unlocking of the shipping container in second virtual world 216.

In an embodiment of the invention, second virtual world 216 may charge the user an unlocking fee to unlock the shipping container or to request a key from first virtual world 202. Furthermore, in another embodiment of the invention, a fee may not be charged until after the shipping container is unlocked and until the user wishes to use asset data 210 in second virtual world 216.

Rendering engine 220 renders asset data 210 to a format compatible with second virtual world 216. Rendering engine 220 may use a number of graphics and modeling languages, or any combination thereof, such as, but not limited to, VRML, OpenGL, and Spline Messes for structure rendering, as well as Renderman, OpenGL, bitmap technology for surface attributes and surface rendering. Authentication engine 222 receives the authentication token from first virtual world 202, and confirms the identity of the user associated with the authentication token.

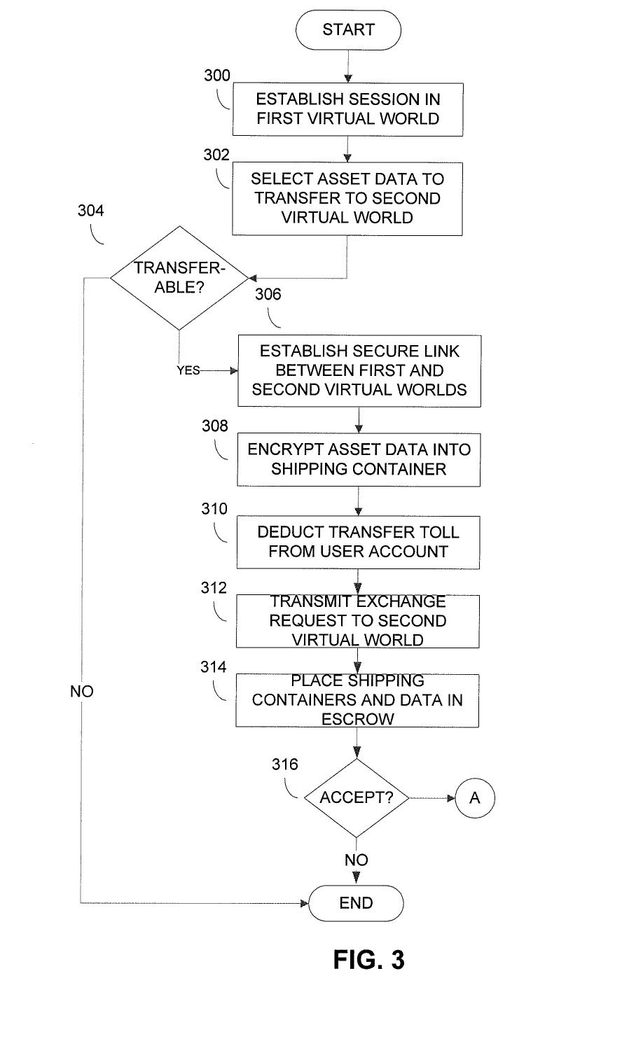

FIG. 3 is a flowchart illustrating the process of moving an avatar from a first virtual world to a second virtual world. Although the steps comprising the flowchart are illustrated in sequential order, many of the steps illustrated in FIG. 3 can be performed concurrently or in an alternative order.

Referring concurrently to FIG. 2 and FIG. 3 simultaneously, the process begins at step 300 where the user establishes a session in first virtual world 202 by interacting with client 200 and establishing first connection 205 with first virtual world 202 through server 201. The process proceeds from step 300 to step 302 where the user selects asset data 210 to transfer from first virtual world 202 to second virtual world 216. The user can select to transfer avatar data 208 and asset data 210 by interacting with client 200.

The process proceeds from step 302 to step 304, where first virtual world 202 checks selected avatar data 208 and asset data 210 to determine if the data is compatible with selected second virtual world 216, and thus transferable. This check can be done through a software algorithm placed on server 201 or through a third-party compatibility check provider. If avatar data 208 and asset data 210 is determined to be compatible, the process proceeds to step 306, where secure communication link 214 is established between first virtual world 202 and second virtual world 216. Link 214 may be established between departure terminal 212 and arrival terminal 218, or between any other points or ports or access channels capable of sending and receiving data on first virtual world 202 and second virtual world 216, respectively. As discussed above, link 214 may be a bilateral communication link capable of two-way communications between first virtual world 202 and second virtual world 216. Link 214 may also be capable of interconnecting more than two virtual worlds simultaneously, and is not limited to being a connection between only two virtual worlds.

In step 308, selected asset data 210 is encrypted into a shipping container by encryption engine 204. The encryption engine 204 may a combination of symmetric (secret-key) and asymmetric (public-key) data encryption to secure asset data 210 into the shipping container. Furthermore, an authenticating digital signature may be recorded onto the shipping container to prevent unauthorized access into the shipping container.

In step 310, a toll is deducted from the user's virtual currency account. The toll may be calculated based on a flat rate, or calculated based on the data or memory size of asset data 210 or the number of individual assets selected as asset data 210 for transmission second virtual world 216.

The process then proceeds from step 310 to 312, where first virtual world 202 sends request message 226 to second virtual world 216 to accept or deny the transfer of avatar data 208 and asset data 210. Second virtual world 216 receives request message 226 and can either accept or deny request message 226. In step 314, first virtual world 202 places the shipping container in an escrow location within first virtual world 202. In step 316, second virtual world 216 can accept or deny request message 226. If second virtual world accepts the request message 226, the process proceeds to step 318, where second virtual world 216 determines if the user has an account on second virtual world 216 and if the user has previously used avatar 207 in second virtual world 216.

If the user has an account on second virtual world 216 and has previously used avatar 207 in second virtual world 216, then the process proceeds from step 318 to step 320, where the shipping container is transmitted from the escrow location to second virtual world 216, and a session of avatar 207 emerges in second virtual world 216 at the same location and time that the user last controlled avatar 207 in second virtual world 216. However, the session of avatar 207 in second virtual world 216 will now have additional avatar data 208 and asset data 210 in second virtual world 216. If the user has not previously used avatar 207 in second virtual world 216, then the process proceeds from step 318 to step 322, where a new session of avatar 207 is initiated in second virtual world 216 using avatar data 208 and asset data 210 transmitted from first virtual world 202.

Then process then proceeds to step 324, where the shipping containers and avatar data 208 are transferred from first virtual world 202 to second virtual world 216 through link 214. Once this data has been received by second virtual world 216, the user identity is verified at step 326 by authenticating the authentication token that is transmitted along with avatar data 208 and asset data 210.

The process then proceeds to step 328, where second virtual world 216 transmits an “unlock” request to first virtual world 202. In step 330, if the “unlock” request is accepted by first virtual world 202, first virtual world 202 in step 332 transmits a digital key for the shipping container to second virtual world 216, where the key can be used to unlock the shipping container in step 334. Alternative forms of decryption may be used to unlock the shipping container, such as a key being encrypted and sent with the asset data 210, or otherwise provided to the user for manual unlocking of the shipping container in second virtual world 216.

In an embodiment of the present invention, shipping containers which have not been unlocked by the user may be transmitted back to first virtual world 202 with asset data 210 from first virtual world 202 intact, with the exception of any loss due to version corrosion as described above.

Finally, in step 336, engine 220 renders asset data 210 into a format compatible with second virtual world 216. Rendering engine 220 may use a number of graphics and modeling languages, or any combination thereof, such as, but not limited to Virtual Reality Modeling Language, OpenGL, Spline Messes for structure rendering, and Renderman, OpenGL, bitmap technology for surface attributes and surface rendering.

While the specification has been disclosed in relation to the exemplary and non-limiting embodiments provided herein, it is noted that the inventive principles are not limited to these embodiments and include other permutations and deviations without departing from the spirit of the invention.

1. A method of interconnecting a plurality of three-dimensional, computer-generated virtual worlds, the method comprising the steps of:
establishing a session in a first virtual world;
selecting an asset from the first virtual world related to an avatar, the asset including a virtual personal item data or a virtual real estate holding data;
determining if the asset is compatible with a second virtual world;
connecting the first virtual world to the second virtual world by defining a link between the first virtual world and the second virtual world;
encrypting the link to prevent a third-party access to data transmitted in the link;
placing the asset in a virtual shipping container encrypted with a plurality of digital signatures;
charging a transfer toll prior to transferring the avatar and the asset from the first virtual world to the second virtual world, the transfer toll payable through a virtual currency;
transmitting a request to transfer the virtual shipping container from the first virtual world to the second virtual world;
placing the shipping container in an escrow location pending an approval to transfer from the second virtual world;
determining if the avatar has previously been accessed within the second virtual world;
transferring the virtual shipping container, the avatar, and an authentication token from the first virtual world to the second virtual world through the link;
receiving the virtual shipping container, the avatar, and the authentication token at an arrival terminal in the second virtual world;
authenticating an identity of an avatar owner corresponding to the avatar using the authentication token;
requesting a key from the first virtual world to decrypt the virtual shipping container;
transmitting the key from the first virtual world to the second virtual world;
unlocking the virtual shipping container with the key in the second virtual world;
rendering the asset in the virtual shipping container through a rendering engine, the rendering of the asset irreversible; and
maintaining the avatar in an invisible state in the second virtual world until the avatar exits the arrival terminal, the avatar remaining editable in the invisible state.
